(19) United States
(12) Patent Application Publication
(10) Pub. No.: US 2007/0143208 A1
(43) Pub. Date: Jun. 21, 2007

(54) Automatic Teller Machine as Lead Source

(76) Inventor: Kristie A. Varga, Gambrills, MD (US)

Correspondence Address: ADVANTIA LAW GROUP, 9035 SOUTH 1300 EAST, SUITE 200, SANDY, UT, 84094, US

(21) Appl. No.: 11/306,275

(22) Filed: Dec. 21, 2005

(51) Int. Cl. G06Q 40/00

(52) U.S. Cl. 705/43; 902/8

(57) ABSTRACT

There is a method of generating a business lead from a user of an automatic teller machine (ATM), including: reading identifying information from an ATM card of the user; presenting the user with a business offer; enabling the user to affirm a desire to be contacted by actuating only a single actuator; gathering user contact information; writing the contact information to the card; associating the contact information with the affirmation of the offer; and providing a business lead to a vendor. There is also: associating the identifying information and the contact information; presenting a second offer; receiving an affirmation of the second offer; accessing the contact information from the storage device according to the association with the identifying information; and associating the contact information with the affirmation of the offer. A record of the offer/acceptance is stored on the card.

### BACKGROUND OF THE INVENTION

1. Field of the Invention

The present invention relates to systems and methods of generating and/or deriving business leads, specifically business leads from users of automatic teller machines.

2. Description of the Related Art

Business leads are an extremely valuable form of connecting clients with service and goods providers. Business leads may be derived from a great variety of sources and vary greatly in quality. For example, a business lead may derive from a subscriber list of an organization whose members may have a likelihood of needing a particular service. Such a business lead typically does not have a high chance of conversion and are typically of low quality. Higher quality leads may be derived from potential customers expressing a particular interest and/or an interest in being contacted regarding a good or service. Such leads typically have a very high conversion rate as there is generally already a need for the good or service. In some instances such a lead will generally purchase from the first vendor to contact the person. Accordingly, such leads are generally very valuable.

Where a service provider receives high quality leads, expenses for acquiring clients may be substantially decreased, thereby providing a competitive advantage to the service provider and decreased costs in providing the service. Therefore, efforts have been made to improve methods of providing business leads, and in particular, methods of deriving business leads of high quality.

It has been observed that Automatic Teller Machines (ATM or ATMs) may be a source of business leads. For example, US Patent Application No. 2003/0040959 by Fei et al., which is incorporated by reference herein in its entirety, discloses a method and apparatus for conducting transactions on an automatic teller machine (ATM). A World Wide Web-enabled ATM provides messages, services and advertisements that are personalized and specifically targeted to the ATM user or that ATM user's market segment. The disclosure describes providing differentiated services to individual customers, targeted advertising to individuals and customer segments, quick transactions based on user-defined preferences, and customer-initiated electronic mail communication, which facilitates further marketing and sales activities related to the targeted advertisements.

Also, in US Patent Application No. 2003/0065563 by Elliott et al., which is incorporated by reference herein in its entirety, discloses a method of and apparatus for automatically displaying an advertisement or promotional material to a user of an automated teller machine or point of purchase terminal. The method includes accessing debit data and credit bureau data for the applicant, accessing account information for the applicant, generating a score for the applicant based on the data and the account information and determining what advertisements or promotional offers to display on the ATM or POP terminal. The apparatus is a system, including both hardware and software components for effecting the method.

More, US Patent Application No. 2005/0060218 to Coutts et al., which is incorporated by reference herein in its entirety, discloses a method of providing immediate assistance to a user of a targeted messaging system. The method involves: identifying a message appropriate for presenting to the user; presenting the message to the user; offering to summon a human agent knowledgeable about products associated with the message; and summoning an agent to speak with the user in response to the user accepting the offer. The method may use a campaign server to supply the appropriate message. A self-service terminal, such as an ATM, may be used to present the message.

While such methods may be capable of generating one or more leads, they fail to capture some potential leads, thereby resulting in costly inefficiencies. Further, some methods fail to adequately qualify the leads. Additionally, it may be difficult or frustrating for a user of an ATM to interact with an ATM participating in such methods, thereby reducing the likelihood that the user may be willing to agree to have information forwarded to a vendor or service provider and or form a relationship with such. For example, a method may include a plurality of acceptance steps and/or may require entering substantial contact information for each lead. Further, it may be difficult for a service provider to meaningfully participate in such a system or method when the service provider is not in a close affiliation with the owner of the ATM.

What is needed is a system, device, article of manufacture, and/or method of deriving business leads from and automatic teller machine that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available methods of deriving business leads. Accordingly, the present invention has been developed to provide a method of deriving business leads from automatic teller machines.

In one embodiment, there is a method of generating a business lead from a user of an automatic teller machine (ATM). The method may include one or more of the following steps: reading identifying information from an ATM card of the user; presenting the user with a business offer relating to the business of the vendor; enabling the user to affirm a desire to be contacted in regards to the business offer; gathering contact information regarding the user, conditional to an affirmation of the business offer by the user; writing the contact information to a storage device; associating the contact information with the affirmation of the offer, thereby forming a business lead; and providing the business lead to the vendor. Also, such a method may include associating the identifying information and the contact information.

A method may further include one or more of the following steps: presenting the user of the ATM with a second offer; enabling the user to affirm a desire to be contacted in regards to the second offer; receiving, from the user, an affirmation of the second offer; accessing the contact information from the storage device according to the association with the identifying information; and associating the contact information with the affirmation of the offer, thereby forming a business lead.

In one embodiment, the storage device is a database and/or the card of the user. A magnetic stripe may be used as a storage device.

In one embodiment, the user may affirm a desire to be contacted in regards to the offer by actuating only a single actuator.

A method of deriving a business lead from a user of an automatic teller machine (ATM) may include one or more of the following steps: reading contact information from a card of the user; presenting the user with an offer; enabling the user to affirm a desire to be contacted in regards to the offer; and associating the contact information with the affirmation of the offer, thereby forming a business lead. A user may affirm a desire to be contacted in regards to the offer by actuating only a single actuator. The presenting step may be conditioned on the user requesting a withdrawal from the ATM. The offer may include a financing offer. The presenting step may be conditioned on the user accessing the automatic teller machine during a defined time frame. There may be a step of delivering the business lead to only a single entity for consumption. There may be a step of reducing a use fee to the user conditional to the affirmation of the offer. There may be a step of reducing a use fee to the user conditional to subsequent successful contact made between the single entity and the user. There may be a step of recording, on the card, that the offer was made. There may be a step of recording, on the card, that the offer was accepted. There may be steps of reading that a previously presented offer was made from a card of the user and selecting the offer to present such that the previously presented offer is not presented. Contact information may be encrypted on the card.

There may be a system comprising one or more devices and/or an article of manufacture comprising a program storage medium readable by a processor and embodying one or more instructions executable by the processor to perform a method of deriving a business lead from a user of an automatic teller machine, comprising one or more of the steps of: reading contact information from a card of the user; presenting the user with an offer; enabling the user to affirm a desire to be contacted in regards to the offer; and associating the contact information with the affirmation of the offer, thereby forming a business lead.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a flowchart describing a method of generating a business lead according to one embodiment of the invention;

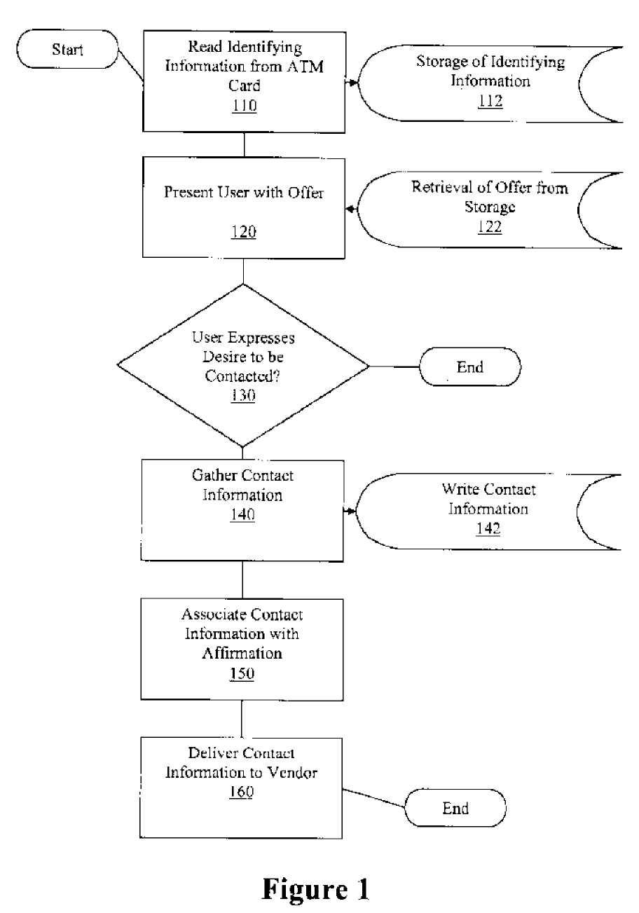

FIG. 2 illustrates a flowchart describing a method of generating a business lead according to one embodiment of the invention;

FIG. 3 illustrates a chart showing a system for generating a business lead according to one embodiment of the invention; and

FIG. 4 illustrates a user view of a step of presenting a user with an offer wherein the user may affirm a desire to be contacted in regards to the offer by actuating only a single actuator.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

As used herein, “comprising,” “including,” “containing,” “is,” “are,” “characterized by,” and grammatical equivalents thereof are inclusive, open-ended terms that do not exclude additional, unrecited elements or method steps.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Looking to the figures, there is shown a method and system for deriving and/or generating a business lead from a user of an automatic teller machine (ATM). The illustrated method includes the following steps: reading identifying information from an ATM card of the user 110; presenting the user with a business offer relating to the business of the vendor 120; enabling the user to affirm a desire to be contacted in regards to the business offer 130; gathering contact information regarding the user, conditional to an affirmation of the business offer by the user 140; writing the contact information to a storage device 142; associating the contact information with the affirmation of the offer 150, thereby forming a business lead; and providing the business lead to the vendor 160. Also, such a method may include associating the identifying information and the contact information.

To more fully explain the above steps, the following description of ATM machines, cards, and other material is provided.

Generally described, an Automatic Teller Machine (ATM) is a data terminal including a plurality of input and output devices. An ATM generally communicates through a host processor that acts as a gateway through which varying ATM networks become available to the user of the ATM. A host processor may connect to the ATM and the ATM network through telephone lines and may be through a dial-up connection or a more dedicated type connection. Such connections and methods of communication are analogous to the internet.

An ATM generally includes a card reader to capture account information stored on the magnetic stripes on the back of ATM/debit or credit cards. This information is generally routed to the host processor and then in turn routed through the ATM network to the user's bank. The user generally also interfaces with the ATM through a keypad and/or screen buttons placed adjacent a screen. Such permit the user to enter information such as PIN numbers and amounts. Further, such permit the user to select from a variety of action choices, such as but not limited to withdrawals, deposits, and account balance queries. Further, an ATM machine generally includes the following output devices: a speaker, a display screen, a receipt printer, and/or a cash dispenser.

As used herein, an ATM card may include an object intended to be carried on a person including readable information thereon sufficient to identify an account. Typically ATM cards are thin, rectangular, and plastic, though none of these properties are required for an object to be an ATM card. For a non-limiting example, an ATM card may be a rubber ball including an RFID chip therein including sufficient information to identify an account. Typical ATM cards include a magnetic stripe or magstripe, similar to magnetic tape found on cassette tapes. Such typically includes tiny iron-based magnetic particles in a plastic-like film. Each particle acts as a tiny bar magnet that may be magnetized in a plurality of orientations. Such orientations may accordingly store information that may be later observed or read.

Generally, the magnetic stripe on an ATM card includes at least three tracks of varying capacity. In particular, typical a typical stripe on the back of an ATM card may include three tracks of information storage. Each track is about one-tenth of an inch wide. The information stored in the tracks typically complies with the ISO/IEC standard 7811 accepted by the banks. Other exemplary standards include ISO standards: 7810, 7811-1 through 7811-6, and 7813. Full copies of these standards and others may be found at www.iso.org and/or www.ansi.org.

The first track generally provides 210 bits per inch (bpi) and holds 79 6-bit plus parity read-only characters. Accordingly, the first track is configured to not be changed once initially written. Track One generally contains codes for country, account number, name, expiration date, and read codes configured to assist in interpretation and error detection during reading.

The second track generally provides 75 bpi and holds 40 4-bit plus parity bit characters. Information stored on the second track typically includes a primary account number, a country code, and expiration date. The third track generally provides 210 bpi with 107 4-bit plus parity characters. Many cards do not use track three. Where track three is used, it may generally include an encrypted PIN, country code, currency units, and amount authorized.

A card reader/writer typically includes a slot through which a card may be “swiped” with the stripe going through the slot, similarly to how magnetic tape on a cassette is drawn across a read/write head. Accordingly, the information on the stripe may be read or written as the stripe passes the head. An exemplary read/write device includes the card read/writer sold under the name MSR505 by Tyner, Inc. which is located at 1151 Daytona Street, Pahrump, Nev. 89048. Such may be interfaced through a personal computer and may be controlled thereby. The card read/writer may read/write to any of tracks one, two, and three and may thereby retrieve and/or alter information stored thereon. In another example, a card read/writer may include a feed mechanism for accepting and holding a card to then be read/written by a head and the card may be returned to the user upon completion of any read/write steps performed upon the card.

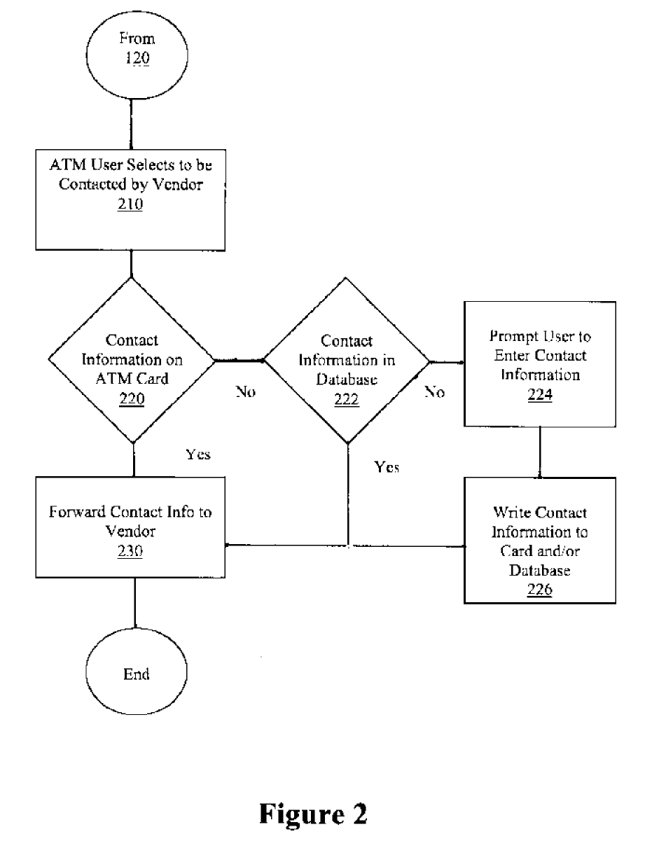

Looking to FIG. 2, there is shown a flowchart describing a method of generating a business lead according to one embodiment of the invention. In particular, there is a decision structure displaying a method of obtaining and preserving contact information upon affirmation of a desire to be contacted. Accordingly, wherein a user desires to be contacted 210 a system, method, device, and/or article of manufacture may determine if sufficient contact information is included on the card and/or has been read from the card already 220. Wherein sufficient contact information may be retrieved just from the card, such is forwarded to a vendor 230. Such forwarding may be by any means known in the art, including but not limited to direct information feed, such as but not limited to mail, email, other electronic delivery, and/or digital voice feed through a phone line. In another non-limiting example, the contact information may be sold and/or auctioned to a vendor or a plurality of vendors.

Wherein sufficient contact information may not be found on the card, a check may be made against a database, such as but not limited to an ATM network, an accessible bank database, and a phone directory. Should sufficient contact information be found within a database, such may then be forwarded to a vendor 230. In one example, contact information from the database may be displayed to the user, who may then confirm the veracity of the contact information, such as but not limited to selecting a “Correct” or “Incorrect” button that may be a screen button. Wherein a user confirms the correctness of contact information, the contact information together with identifying information from the card may be stored together, such as but not limited to being stored in a database, network, and/or on the card using a card read/writer or card writer, such as may be done in step 226 in the figures. Identifying information is such information required to uniquely identify a card, a user, and/or an account. Non-limiting examples include account numbers, names, identification numbers, and other codes, alone and in conjunction.

Wherein sufficient contact information may not be found on any storage device or system, the user may be asked to provide such contact information 224. Contact information is deemed sufficient if a vendor may successfully contact a user using the information. In one example a name may be sufficient contact information and may be retrieved from Track One of a magnetic stripe of an ATM card. In another example a phone number for a cell phone may be sufficient contact information. A further example includes an email address. The user may be provided with a query displayed on the screen and may be requested to enter contact information, such as but not limited to entering a phone number by means of a keypad. Upon successful entering of contact information, such contact information may be written to a storage device 226 such as but not limited to a card of the user and/or a database that may be accessible to the ATM or ATM network, such that upon a subsequent iteration of a method described herein, contact information may be available without requesting such from the user. In one non-limiting example, a card writer included within the ATM may write contact information to Track Three of the card of the user. After writing the contact information, the lead, being the contact information related to the affirmation of a desire to be contacted, may be forwarded to a vendor 230.

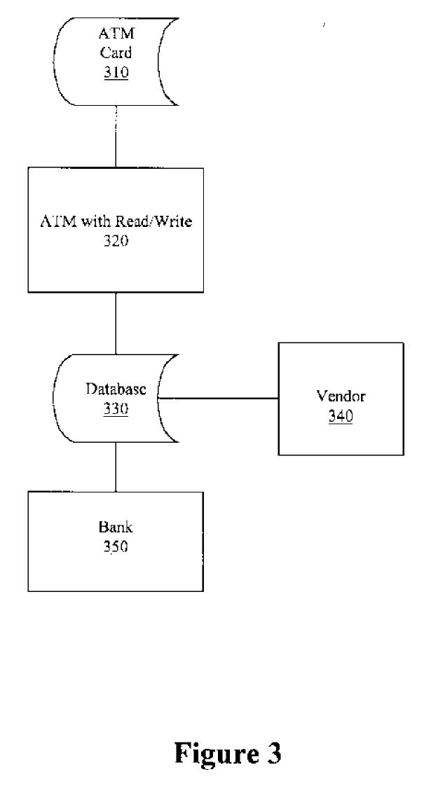

FIG. 3 displays a system according to one embodiment of the invention. There is shown an ATM card or card module 310 of a user that may be a personal object including information readable by an ATM or ATM module 320. The ATM 320 may include read/write capability such that information contained by the ATM card 310 may be accessed and/or changed by the ATM 320. Further, there is shown a database or database module 330 in information communication with the ATM 320. The database 330 may or may not be in information communication with an ATM network. The database 330 may be a proprietary database owned by the owner of the ATM 320. In the illustrated example, the database 330 is in communication with the Bank or Bank module 350 of the user and accordingly would be typically in communication with an ATM network. Further, the database 330 is in communication with a Vendor or Vendor module 340 to whom a lead may be transmitted.

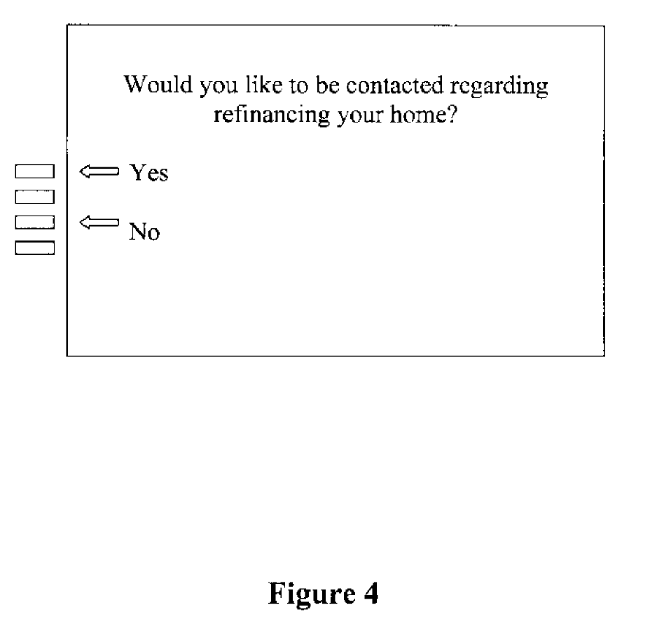

FIG. 4 illustrates an exemplary offer to a user, wherein an option to express a desire to be contacted may be exercised by pressing a single screen button as indicated by the button to which the “Yes” arrow points. Accordingly, wherein contact information may be derived from the card of the user, a user may request more information from a Vendor with a single press of a button.

A method may further include one or more of the following steps: presenting the user of the ATM with a second offer; enabling the user to affirm a desire to be contacted in regards to the second offer; receiving, from the user, an affirmation of the second offer; accessing the contact information from the storage device according to the association with the identifying information; and associating the contact information with the affirmation of the offer, thereby forming a business lead. As used herein, “associating . . . information” includes any logical association relating information together. In one non-limiting example, a first information may be stored together in a single logical location with a second information, such as but not limited to storing both information in a virtual file folder and/or together in a single file and/or record in a database. In another non-limiting example, first and second information may be stored together on a single storage device such as on a ATM card, including wherein the first information is stored on a different track than the second information.

In one embodiment, the storage device is a database and/or the card of the user. A magnetic stripe may be used as a storage device. A storage device may be a read/write device. A storage device may be a read-only device and/or may include one or more read-only portions. A storage device may be a module.

In one embodiment, the user may affirm a desire to be contacted in regards to the offer by actuating only a single actuator. An actuator may be any means for registering an expression by a user. Non-limiting examples, include touch screens, buttons, levers, switches, and presenting a card for a second read.

A method of deriving a business lead from a user of an automatic teller machine (ATM) may include one or more of the following steps: reading contact information from a card of the user; presenting the user with an offer; enabling the user to affirm a desire to be contacted in regards to the offer; and associating the contact information with the affirmation of the offer, thereby forming a business lead. A user may affirm a desire to be contacted in regards to the offer by actuating only a single actuator. The presenting step may be conditioned on the user requesting a withdrawal from the ATM. The offer may include a financing offer.

The presenting step may be conditioned on the user accessing the automatic teller machine during a defined time frame. In one example, an offer may only be presented during a lunch hour, such as but not limited to a time period between 11 AM and 1 PM. There may be a step of delivering the business lead to only a single entity for consumption. Consumption is defined as use of the contact information, such as but not limited to contacting the user.

There may be a step of reducing a use fee to the user conditional to the affirmation of the offer. ATM owners typically charge a fee for using the ATM. Banks typically also charge a fee for access to records through the ATM network. One or more of these fees or similar fees may be waived in whole or in part. In one example, a user may be reimbursed an amount of a use fee, such as those fees typically charged to a user upon use of an ATM not owned by the bank holding the account through which money is accessed. There may be a step of reducing a use fee to the user conditional to subsequent successful contact made between the single entity and the user.

There may be a step of recording, on the card, that the offer was made. There may be a step of recording, on the card, that the offer was accepted. There may be steps of reading that a previously presented offer was made from a card of the user and selecting the offer to present such that the previously presented offer is not presented. In one example, “cookies” such as those used by hosts of internet content, may be placed on a card of a user. Such “cookies” may be used to store information for easy retrieval later, to identify a card as earning a particular status or benefit, etc. Information written to a card may be encrypted. Encryption may be one-way encryption, such as but not limited to encryption used with PIN numbers, wherein a key is required. Contact information may be encrypted on the card.

There may be a system comprising devices or an article of manufacture comprising a program storage medium readable by a processor and embodying one or more instructions executable by the processor to perform a method of deriving a business lead from a user of an automatic teller machine, comprising one or more of the steps of: reading contact information from a card of the user; presenting the user with an offer; enabling the user to affirm a desire to be contacted in regards to the offer; and associating the contact information with the affirmation of the offer, thereby forming a business lead.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the figures describe using minimal contact information, it is also contemplated that a plurality of sources may be mined for contact information, thereby enhancing the quality of the contact information. As a non-limiting example, contact information may be gleaned from the card, from a database, and also requested of the user and written to the card and/or a database.

Additionally, although the figures illustrate using an ATM card. Any means of providing identifying information may be used, including but not limited to RFID chips, bar codes, 2-D bar codes, and keying in the identifying information. Further, writing information to a card may be accomplished using a separate card such as a card provided by the machine from a stock of blank cards fed through the card writer.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method of generating a business lead from a user of an automatic teller machine (ATM), comprising the steps of:
reading identifying information from an ATM card of the user;
presenting the user with a business offer relating to the business of the vendor;
enabling the user to affirm a desire to be contacted in regards to the business offer;
gathering contact information regarding the user;
writing the contact information to a storage device;
associating the contact information with the affirmation of the offer, thereby forming a business lead; and
providing the business lead to the vendor.

2. The method of claim 1, further comprising associating the identifying information and the contact information.

3. The method of claim 2, further comprising:
presenting the user of the ATM with a second offer;
enabling the user to affirm a desire to be contacted in regards to the second offer;
receiving, from the user, an affirmation of the second offer;
accessing the contact information from the storage device according to the association with the identifying information; and
associating the contact information with the affirmation of the offer, thereby forming a business lead.

4. The method of claim 1, further comprising the step of conditioning the gathering step on an affirmation of the business offer by the user.

5. The method of claim 1, wherein the storage device is the card of the user.

6. The method of claim 5, wherein the storage device further comprises a magnetic stripe.

7. The method of claim 1, wherein the user affirms a desire to be contacted in regards to the offer by actuating only a single actuator.

8. A method of deriving a business lead from a user of an automatic teller machine (ATM), comprising the steps of:
reading contact information from a card of the user;
presenting the user with an offer;
enabling the user to affirm a desire to be contacted in regards to the offer; and
associating the contact information with the affirmation of the offer, thereby forming a business lead.

9. The method of claim 8, wherein the user affirms a desire to be contacted in regards to the offer by actuating only a single actuator.

10. The method of claim 9, further comprising the step of conditioning the presenting step on the user requesting a withdrawal from the ATM.

11. The method of claim 10, wherein the offer comprises a financing offer.

12. The method of claim 10, further comprising the step of conditioning the presenting step on the user accessing the automatic teller machine during a defined time frame.

13. The method of claim 10, further comprising delivering the business lead to only a single entity for consumption.

14. The method of claim 10, further comprising reducing a use fee to the user conditional to the affirmation of the offer.

15. The method of claim 13, further comprising reducing a use fee to the user conditional to subsequent successful contact made between the single entity and the user.

16. The method of claim 8, further comprising recording, on the card, that the offer was made.

17. The method of claim 8, further comprising recording, on the card, that the offer was accepted.

18. The method of claim 16, further comprising:
reading that a previously presented offer was made from a card of the user; and
selecting the offer to present such that the previously presented offer is not presented.

19. The method of claim 8, wherein the contact information is encrypted on the card.

20. An article of manufacture comprising a program storage medium readable by a processor and embodying one or more instructions executable by the processor to perform a method of deriving a business lead from a user of an automatic teller machine, comprising the steps of:
reading contact information from a card of the user;
presenting the user with an offer;
enabling the user to affirm a desire to be contacted in regards to the offer; and
associating the contact information with the affirmation of the offer, thereby forming a business lead.
